(19) United States
(12) Patent Application Publication
(10) Pub. No.: US 2005/0087400 A1
(43) Pub. Date: Apr. 28, 2005

(54) Electric motor, elevator with a car movable by an electric motor, and elevator with a car and with an electric motor for movement of a guide element relative to the car

(76) Inventor: Tian Zhou, Reussbuhl (CH)

Correspondence Address: MACMILLAN SOBANSKI & TODD, LLC;ONE MARITIME PLAZA FOURTH FLOOR, 720 WATER STREET, TOLEDO, OH, 43604-1619, US

(21) Appl. No.: 10/917,572

(22) Filed: Aug. 13, 2004

(30) Foreign Application Priority Data
Aug. 14, 2003 (EP) 03405593.9

(51) Int. Cl. B66B 1/00

(52) U.S. Cl. 187/277; 318/135

(57) ABSTRACT

An electric motor includes a primary part for producing a traveling magnetic field and a secondary part for providing a static magnetic field, wherein the secondary part and the primary part are movable relative to one another under an effect of the travelling magnetic field. The secondary part has a device with a substrate and a conductor track, which track is applied to the substrate, in the form of a layer structure, wherein the conductor track can be supplied with an electric current for the purpose of producing the static magnetic field.

### BACKGROUND OF THE INVENTION

The present invention relates to an electric motor and to an elevator with a car movable along a path by means of such an electric motor.

A further subject of the present invention is an elevator with a car movable along at least one guide surface, with a guide element which is arranged at the car to be movable and which is brought into contact with the guide surface, and with an electric motor for movement of the guide element relative to the car.

Electric motors of the aforesaid kind are shown in European Patent Applications EP 0 949 748 A1 and EP 0 949 749 A1. In these patent applications there are described linear motors which each comprise a primary part for producing a travelling magnetic field and a secondary part for providing a static magnetic field, wherein the secondary part and the primary part are physically separated by an air gap and are movable relative to one another under an action of the travelling magnetic field. For producing the travelling magnetic field the primary part comprises several flat air-core coils which are applied as printed circuits to an insulating substrate. The coils are connected in series in such a manner that they produce a magnetic field, which travels along a surface of the substrate, when an electric alternating current flows through the coils. For providing the static magnetic field several permanent magnets are arranged in the secondary part in such a manner that a periodic magnetic structure, which has a periodic reversal of the polarity of the respective magnetization, is formed at a surface of the secondary part. This magnetic structure provides a static magnetic field with a periodic variation of the field strength. As coils for the primary part there are proposed several configurations, which are constructed for supply with alternating current with one phase or with several phases. These linear motors have the disadvantage that the secondary part has a high weight due to being equipped with permanent magnets. Moreover, the use of permanent magnets leads to high piece costs, since on the one hand permanent magnets are usually comparatively expensive and moreover production of a secondary part composed of a plurality of permanent magnets is expensive and thus connected with high costs. The cost for production of the secondary part rises, with corresponding consequences for production costs, particularly when the permanent magnets have to correspond as precisely as possible in the dimensions thereof and have to be arranged parallel to one another with the greatest possible precision in such a manner that their surfaces form a flat surface. The latter is relevant in the case of precision motors and in the case of high-efficiency motors having a narrow air gap between the primary part and the secondary part.

An elevator with a drive system for a car on the basis of a linear motor operated as a synchronous motor is disclosed in European Patent Application EP 0 785 162 A1. The linear motor comprises a primary part for producing a travelling magnetic field and a secondary part for providing a static magnetic field, wherein the secondary part and the primary part are physically separated by an air gap and are movable relative to one another under an action of the travelling magnetic field. The car can be held at predetermined positions in an elevator shaft or moved along a predetermined path solely by the linear motor, i.e. without co-action of further support means or a counterweight. The secondary part consists of a plurality of permanent magnets, which are arranged at a wall of an elevator shaft along the path of the car. The primary part consists of coils which are arranged at a side of the car and which, depending on the respective construction, can be controlled in two-phase or three-phase by alternating current in order to produce the travelling magnetic field. The car is guided in such a manner that in the case of movement of the car the primary part and the secondary part of the linear motor are movable relative to one another at a substantially constant spacing. In the present case the permanent magnets of the secondary part take up a relatively large area at the shaft wall. This construction of the secondary part thus leads to high material and production costs and the installation of the secondary part in the elevator shaft is expensive due to the large weight of the permanent magnets. Since the secondary part provides permanent high static magnetic fields over the entire length of the elevator shaft appropriate precautionary measures have to be taken during installation of the secondary part and generally during maintenance operations in the elevator shaft in order to avoid undesired effects of the magnetic fields. This is expensive and accordingly disadvantageous.

Electric motors of the above-mentioned kind are used in elevators in order to be able to damp vibrations of a car which can occur during movement of the car transversely to the direction of movement. An elevator with a car is known from European Patent Application EP 0 731 051 A1 which is guided along guide rails by means of several roller guides. Each roller guide comprises three guide elements in the form of rollers which are each brought into contact with a respective guide surface on one of the guide rails and which roll over the respective guide surfaces when the car is moved along the guide rails. The guide elements are each arranged to be movable relative to the car. Each roller guide comprises two linear motors by which the respective position of the guide elements with respect to the car is controllable in such a manner that the car is movable relative to the guide elements in two directions perpendicular to the direction of movement of the car. Vibrations of the car transversely to the direction of movement thereof are detected by inertial sensors. Depending on signals of the inertial sensors, a control causes the linear motors to move the guide elements in such a manner that compensation is provided each time for vibrations of the car. Each linear motor comprises a primary part for producing a travelling magnetic field and a secondary part for providing a static magnetic field, wherein the secondary part and the primary part are movable relative to one another under an action of the travelling magnetic field. The primary part consists of two ferromagnetic lamination stacks with respectively the same shape. Each of the lamination stacks comprises three teeth which are arranged adjacent to one another and between which a respective groove is formed. Each of the lamination stacks carries a respective coil, the windings of which are laid around the center tooth and through the grooves adjoining this tooth. The two lamination stacks are arranged in mirror image with respect to a plane in such a manner that the teeth of the lamination stacks are respectively disposed opposite one another in pairs and are separated by an air gap. Arranged in that manner, the lamination stacks together with the coils form an electromagnet with three pole pairs. In the case of a like-phase drive control of the coils by electric current there is produced in the lamination stacks a magnetic flux in such a manner that adjacent teeth of each lamination stack are respectively magnetized with different polarity. Correspondingly, in the case of a like-phase drive control of the coils with alternating current a magnetic field travelling between the teeth is produced in the air gap. The secondary part, influenced by this travelling magnetic field, of the respective linear motor can be moved. Each secondary part is movably arranged in the air gap between the two lamination stacks of the respective primary part and consists each time of the flat plate on which permanent magnets are arranged. In the present case the primary part of each linear motor is arranged in stationary position at the car, whilst the secondary part of each linear motor is respectively connected with at least one of the guide elements. The construction of these linear motors is disadvantageous in many respects. The motors are, as a consequence not only of the mode of construction of the primary part, but also due to the mode of construction of the secondary part, bulky and heavy. This is disadvantageous, because typically eight linear motors are required for damping the vibrations of a car. In the present case the linear motors significantly contribute to the overall weight of the elevator. Due to the large weight of the primary part or secondary part of the motors, high magnetic fields have to be produced between primary part and secondary part in order to achieve a predetermined acceleration. This is disadvantageous when rapid movements have to be regulated by these motors. Moreover, the width of the air gap between the lamination stacks is relatively large, since the permanent magnets of the secondary part have a relatively large space requirement. This is detrimental to the efficiency of the linear motors. Moreover, production of the primary part is expensive, since the manufacture of the lamination stacks and the windings of the coils are costly. A further disadvantage is to be seen in that a magnetic interaction exists between the permanent magnets of the secondary part and the lamination stacks of the primary part. This magnetic interaction can lead to occurrence of disturbance forces which make difficult a precise controlling of the position of the secondary part or of the movement of the secondary part relative to the primary part.

In U.S. Patent Application Publication 2003/0000778 A1 there is disclosed an elevator, the car of which can be moved by means of a linear motor. The secondary part of the linear motor can comprise either wound coils or a combination of such coils and permanent magnets. Coils of that kind are usually wound on an iron core. The linear motor accordingly has a high weight and a large volume. Production thereof is, moreover, costly, since it has to be assembled from numerous individual parts.

### SUMMARY OF THE INVENTION

It is an object of the present invention to avoid the stated disadvantages of the known electric motors and to create an electric motor which has a compact construction, has a low weight and brings therewith the precondition for economic manufacture. This electric motor shall be suitably dimensioned for use in an elevator as a drive for movement of a car or for movement of a guide element relative to the car.

The electric motor according to the present invention comprises a primary part for producing a travelling magnetic field and a secondary part for providing a static magnetic field, wherein the secondary part and the primary part are movable relative to one another under an effect of the travelling magnetic field. The secondary part comprises a conductor track which is arranged on a substrate and which can be supplied with an electric current for the purpose of producing the static magnetic field.

The special construction of the secondary part enables provision of a static magnetic field without the use of permanent magnets. The static magnetic field necessary for operation of the electric motor is produced electromagnetically in that an electric current is supplied by way of the conductor track. All disadvantages which accompany the use of permanent magnets are thus avoided.

According to the invention the secondary part comprises, as essential basic element, a substrate which serves as support for the conductor track and ensures the desired mechanical rigidity of the secondary part. The precondition is thereby created for construction of a secondary part which is compact, has a low weight and can be produced economically. The substrate and the conductor track can be constructed as a layered structure. The conductor track can be formed from, for example, a thin electrically conductive layer applied to a substrate and optionally suitably structured. With respect to construction and manufacture of the secondary part, technologies developed for printed circuits are in that case usable. This allows economic manufacture.

The substrate can be made from a material of high strength. This enables use of thinner substrates with a large surface. Thus, there can be created a secondary part, which is extremely narrow in one dimension and thus can be moved through a particularly narrow air gap between two poles of a pole pair of a primary part. Since the conductor track can be formed from a thin, conductive layer, it is possible to create a secondary part which has a relatively smooth surface in the region of the conductor track. It is thereby possible to create an electric motor in which the secondary part can be arranged at a particularly small spacing from the primary part and which is accordingly operable with high efficiency.

The electric motor can be realized in a number of configurations. The shape of the substrate can—adapted each time to the shape of the primary part—be correspondingly selected. The electric motor can be constructed as, for example, a rotating motor. The electric motor can, however, also be designed for other forms of movement, for example as a linear motor. The substrate can have, for example, the shape of a cylinder. In this case the conductor track can be arranged on, for example, the circumference of the cylinder in order to form a secondary part rotatable about the longitudinal axis of the cylinder. The secondary part can also be constructed as a flat disc rotatable about an axis. In this case the basic surfaces of the disc are available for arrangement of the conductor track. Alternatively, for example in the case of a linear motor, the secondary part can also be constructed as a flat plate movable along a track with a finite length, wherein the base surfaces of the plate are available for arrangement of the conductor track.

The secondary part of one form of embodiment of the electric motor according to the present invention can be conceived as a layered structure produced by application of different layers on the substrate. The layers can be applied in succession and optionally suitably structured. In this manner three-dimensional structures of materials with different characteristics can be applied to the substrate. Individual layers can consist of an electrically insulating material or comprise regions of an electrically insulating material. The conductor track can be composed of conductor track sections respectively formed in different layers of the layer structure. Individual sections of the conductor track can cross over, for example, in different planes and be separated in the crossover region by an electrically insulating layer. Moreover, the possibility exists of arranging individual sections of the conductor track in different layers separated by an intermediate layer and providing in the intermediate layer an electrically conductive region which produces an electrical connection between these sections of the conductor track.

Layers of the stated kind can also be applied on both sides of the substrate and optionally structured. In the case of the secondary part of a further form of embodiment of the electric motor according to the present invention it is provided, for example, that a first part of the conductor track is formed at a first surface of the substrate and a second part of the conductor track at a second surface of the substrate, wherein an electrical connection is produced between the first and the second part. This makes it possible to impart a particularly complex geometric structure to the conductor track.

In a variant of the secondary part at least one section of the conductor track can have, for example, the form of a coil, wherein each coil comprises one or more windings. The coil can be arranged on one side of a substrate, but it can also be composed of different sections of the conductor track which are arranged on different sides of the substrate and electrically connected together.

In a further variant of the secondary part several serially arranged sections of the conductor track can each have the form of a coil, wherein the coils are constructed in such a manner that, in the case of a current flow through the conductor track, adjacent coils produce respective magnetic fields with different polarity. The conductor track can be arranged in such a manner that, for example, in the case of supply of the conductor track with a direct current there is produced at a surface of the secondary part a static magnetic field, the polarity of which has a periodic polarity reversal along the direction in which the secondary part is movable relative to the primary part. In this manner a secondary part for provision of a large number of magnetic poles can be constructed. With a suitable arrangement of the conductor track the area available on the substrate can be efficiently utilized. This is relevant for optimization of the efficiency of the electric motor and the accuracy with which the movement of the secondary part relative to the primary part can be controlled during operation of the motor.

In a further development of the secondary part there can also be provided, for producing a static magnetic field, several conductor tracks which can be supplied with an electric current independently of one another. A static magnetic field with a particularly large energy density can be produced by a secondary part constructed in that way. On the basis of this concept, the maximum force with which the secondary part is moved relative to the primary part during operation of the motor can be additionally increased.

A further development of the electric motor according to the present invention has a primary part which comprises a conductor track arranged on the substrate, wherein this conductor track can, for the purpose of producing the travelling magnetic field, be supplied with an electric current having a current intensity which varies with time. In the case of this construction of the electric motor the primary part can be realized according to the same technological concept on which the design of the secondary part is based according to the invention. For producing the travelling magnetic field there is thus provided an electrical structure which can be realized as a layered structure, for example by application of thin layers on a substrate and optionally by a structuring of these layers. For example, several serially arranged sections of the conductor track can each have the form of a coil, wherein the coils are constructed in such a manner that in the case of current flow through the conductor track adjacent coils produce respective magnetic fields with different polarity. Thus, not only the primary part, but also the secondary part can be realized as layer structures comprising thin electrically conductive regions applied to a substrate. Consequently, not only the primary part, but also the secondary part can be produced by techniques in use for fabrication of printed circuits.

This variant of the electric motor according to the present invention has several advantages. Thin substrates, which additionally have a low weight, can be respectively used for the primary part and the secondary part. By contrast with conventional motor constructions, in the present case neither a ferromagnetic core nor wound coils nor permanent magnets are required for producing the magnetic travelling field or for producing the static magnetic field. This variant of the electric motor can accordingly be constructed to be particularly light, compact and favorable in price. The possibility within the scope of the invention of being able to realize the primary part and the secondary part without ferromagnetic cores and without permanent magnets also simplifies control of the movement of the secondary part during operation of the electric motor, since the interference forces which arise in the case of conventional electric motors between a ferromagnetic core (usually provided with teeth and grooves) and the secondary part are eliminated. Due to the low weight the motor is particularly well suited for control of rapid movements. Since only low masses have to be accelerated in the case of control of the motor, rapid movements can be controlled efficiently and precisely.

In a further development of the aforesaid variant of the electric motor according to the present invention it is provided that the primary part comprises several conductor tracks arranged on a substrate and that each of these conductor tracks can for the purpose of producing the travelling magnetic field be respectively supplied with electric current having a current intensity varying with time. Since each of the conductor tracks can be controlled independently by a current source, an electric motor controllable in multi-phase can be devised in accordance with this concept.

The electric motor according to the present invention can also be used in an elevator as a drive for a car movable along a path. The electric motor can be installed in the elevator in such a manner that, for example, the primary part is arranged in stationary position along the path and the secondary part at the car. Alternatively, the secondary part can be arranged in the stationary position along the path and the primary part at the car. In addition, the elevator can be equipped with means for guiding the car along the path and the primary part and the secondary part can be arranged at these means in such a manner that the primary part and the secondary part are guided at a spacing from one another when the car is moved along the path. The latter has the advantage that every movement of the electric motor and every movement of the car are controlled by a common guide. A separate guide for the primary part or the secondary part of the electric motor can in this way be saved.

In an elevator which comprises a car movable along the guide surface and a guide element which is movably arranged at the car and brought into contact with the guide surface, the electric motor according to the present invention can also be used as a drive for movement of the guide element relative to the car. The electric motor can in that case be installed in such a manner that the primary part is arranged to be movable together with the guide element and the secondary part is arranged to be stationary with respect to the car or that the secondary part is arranged to be movable together with the guide element and the primary part is arranged to be stationary with respect to the car. Moreover, a control for the electric motor for reduction of vibrations of the car, which can arise during movement of the car, can be integrated in the elevator.

### DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1A is a plan view of an electric motor according to the present invention, with a primary part movable relative to a secondary part;

FIG. 1B is a cross-sectional view of the electric motor taken along a line 1B-1B in FIG. 1A;

FIG. 2A is a plan view of a portion of another electric motor according to the present invention, with a primary part and a secondary part, wherein the secondary part is movable relative to the primary part;

FIG. 2B is a cross-sectional view of the electric motor taken along a line 2B-2B in FIG. 2A;

FIG. 3A is a schematic illustration of the primary part shown in FIG. 1A;

FIG. 3B is a schematic illustration of the secondary part shown in FIG. 1A;

FIG. 3C is a cross-sectional view of the secondary part taken along the line 3C-3C in FIG. 3B;

FIG. 4A is a fragmentary elevation view of an elevator with a car and a guide element for guidance of the car and with an electric motor according to the present invention for movement of the guide element relative to the car;

FIG. 4B is a cross-sectional view of the electric motor taken along the line 4B-4B in FIG. 4A;

FIG. 5A is a fragmentary elevation view of an elevator with a car and an electric motor according to the present invention as a drive for movement of the car; and

FIG. 5B is a cross-sectional view of the elevator taken along the line 5B-5B in FIG. 5A.

### DESCRIPTION OF THE PREFERRED EMBODIMENT

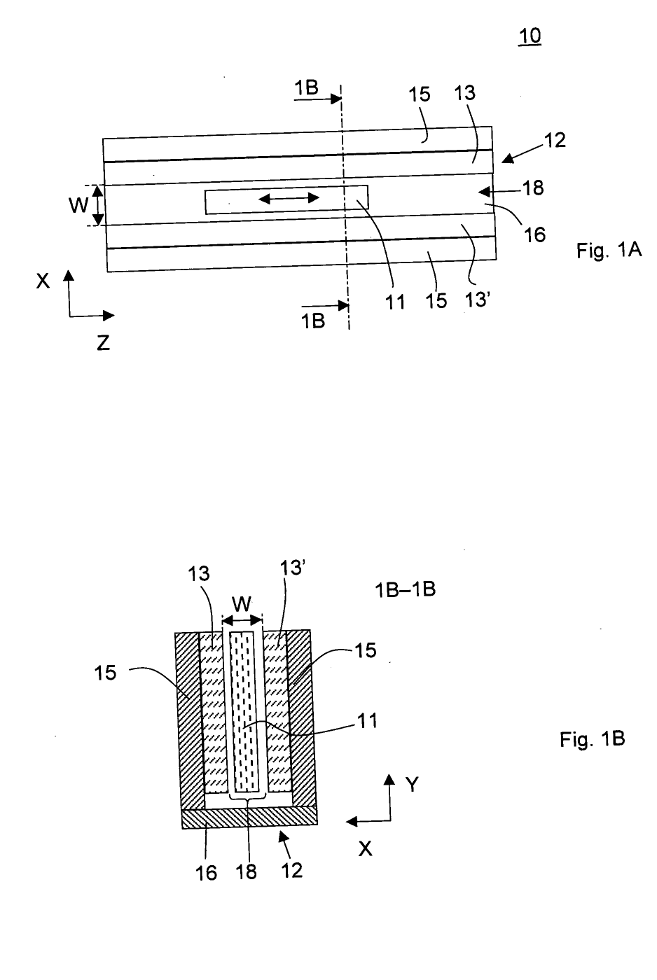

FIG. 1A shows an electric motor 10 according to the present invention, which comprises a primary part 11 for producing a travelling magnetic field and a secondary part 12 for providing a static magnetic field. FIG. 1B shows the electric motor 10 in cross section taken along the line 1B-1B in FIG. 1A.

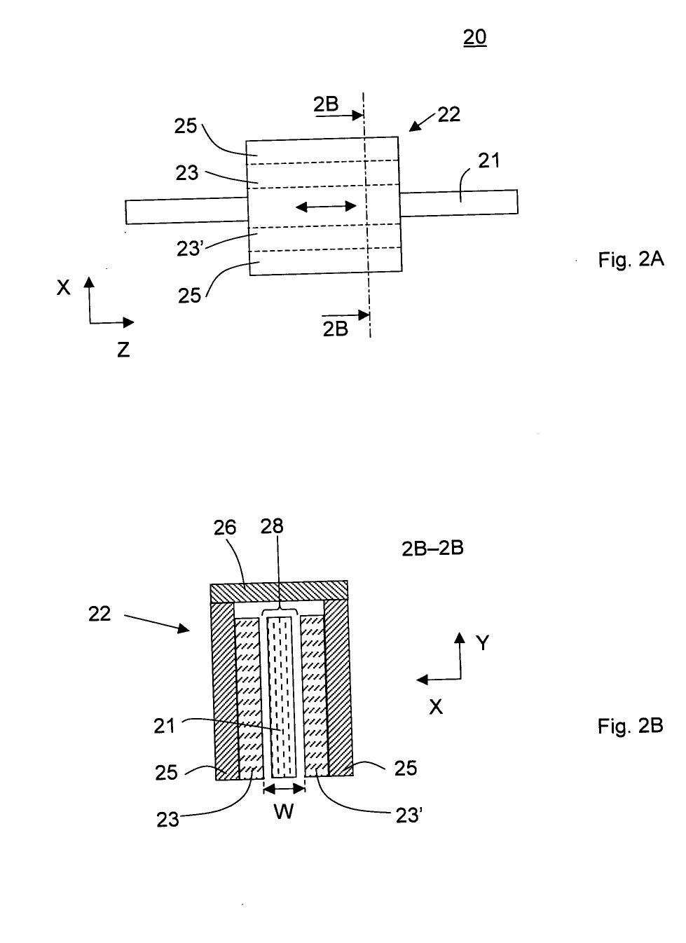

FIG. 2A shows an electric motor 20 according to a second embodiment of the present invention, which comprises a primary part 21 for producing a travelling magnetic field and a secondary part 22 for providing a static magnetic field. FIG. 2B shows the electric motor 20 in cross section taken along the line 2B-2B in FIG. 2A.

The electric motors 10 and 20 are both conceived as linear motors. The primary part 11 and the secondary part 12, or the primary part 21 and the secondary part 22, are each so constructed that the part 11, 22 is movable relative to the associated part 12, 21, in a “Z” direction of a co-ordinate system “XYZ”, as indicated in FIG. 1A by a double arrow on the primary part 11 and in FIG. 2A by a double arrow on the secondary part 22.

The electric motors 10 and 20 essentially differ by the amount of the longitudinal extent of the primary part 11 or 21 and the secondary part 12 or 22 in the respective “Z” direction. In the case of the electric motor 10 the primary part 11 has, by comparison with the secondary part 12, a smaller length in the “Z” direction. The electric motor 10 is therefore preferably usable in applications in which the primary part 11 (by contrast with the secondary part 12) has to be moved through a relative large distance. In the case of the electric motor 20, the primary part 21 has by comparison with the secondary part 22 a greater length in the “Z” direction. The electric motor 20 is therefore preferably usable in applications in which the secondary part 22 (by contrast with the primary part 21) has to be moved over a relative large distance.

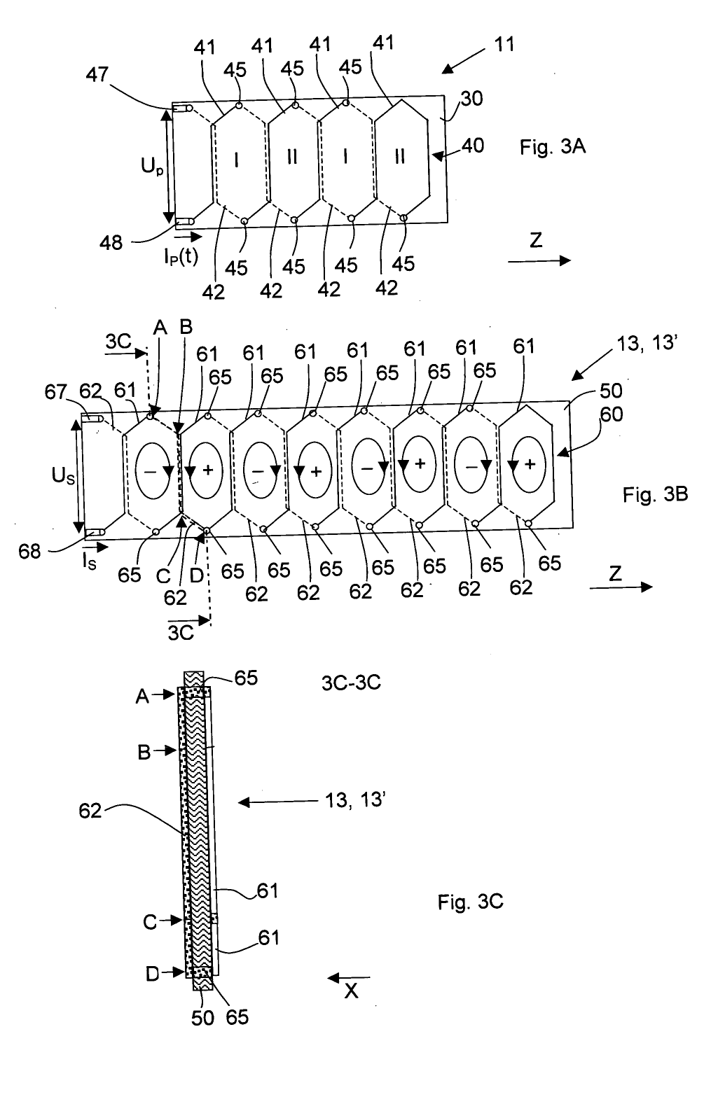

The secondary part 12 comprises two devices 13, 13′ which have the form of a rectangular plate and are arranged parallel to the “Z” direction at such a spacing from one another that they bound by an air gap 18 of a width W. The devices 13 and 13′ are respectively fastened to supports 15, which in turn are fixed to a base plate 16. The primary part 11 is shaped and arranged in such a manner that it is movable in the air gap 18 in the “Z” direction. A conventional guide (not illustrated in FIGS. 1A and 1B) is provided in order to guide the primary part 11 in the “Z” direction during movement relative to the secondary part 12. The devices 13 and 13′ each comprise electromagnetic means which are described in more detail in the following in connection with FIGS. 3B-C and each serve for providing a static magnetic field. This magnetic field is usually produced in such a manner that it is present in the air gap 18, but in certain circumstances also on the sides of the devices 13 and 13′ remote from the air gap 18. In order to concentrate a magnetic flux in a smallest possible space on the sides of the devices 13 and 13′ remote from the air gap the supports 15 can be made of a soft magnetic material.

The secondary part 22 is constructed analogously to the secondary part 12 with respect to its structure and its function.

The secondary part 22 comprises two devices 23, 23′ which have the form of a rectangular plate and which are arranged parallel to the “Z” direction at such a spacing from one another that they bound an air gap 28 of the width W. The devices 23 and 23′ are respectively fastened to supports 25 which in turn are fixed to a base plate 26. The primary part 21 is shaped and arranged in such a manner that it is movable in the air gap 28 in the “Z” direction. A conventional guide (not illustrated in FIGS. 2A and 2B) is provided in order to guide the secondary part 22 in the “Z” direction during movement relative to the primary part 21. The devices 23 and 23′ each comprises electromagnetic means which are described in more detail in the following in connection with FIGS. 3B-C and which each serve for providing a static magnetic field. This magnetic field is usually produced in such a manner that it is present in the air gap 28, but in certain circumstances also on the sides of the devices 23 and 23′ remote from the air gap 28. In order to concentrate a magnetic flux in a smallest possible space on the sides of the devices 23 and 23′ remote from the air gap 28 the supports 25 can be made from a soft magnetic material.

The primary parts 11 and 22 respectively comprise electromagnetic means which are described in more detail in connection with FIG. 3A and which have the function of producing a travelling magnetic field. The said electromagnetic means are preferably so constructed that they are suitable for producing a travelling magnetic field in the “Z” direction.

FIG. 3A illustrates the primary part 11 in a plan view in the “X” direction. FIG. 3B shows—similarly in plan view in the “X” direction—the device 13 or the device 13′, which corresponds identically with the device 13. FIG. 3C shows the device 13 or 13′ in a cross-section 3C-3C according to FIG. 3B along the polygon course characterized in FIG. 3B by points “A”, “B”, “C” and “D”.

The primary part 11 comprises a substrate 30, on the base surfaces of which a conductor track 40 is applied. The conductor track 40 has two ends that are each connected with a respective electrical terminal 47 or 48. An electrical voltage U_{P} can be applied to the electrical terminals 47 and 48 in order to supply the conductor track 40 with an electric current I_{P}. The conductor track has two conductor track sections 41 and 42 which are respectively arranged on different sides of the substrate 30 and are connected together at their respective ends each time by way of an electrical connection 45. For clarification, the conductor track sections 41 disposed on the base surface of the substrate 30 facing the observer are illustrated by respective solid lines and the conductor track sections 42 disposed on the base side of the substrate 30 remote from the observer are illustrated by respective dashed lines. The conductor track sections 41 and 42 are connected in series in such a manner that several coils each with a respective winding are formed on the substrate 30. The coils are in that case lined up in the “Z” direction to lie directly adjacent to one another. The conductor track sections 41 and 42 are connected in such a manner that adjacent coils are flowed through by the current I_{P} each time with an opposite sense of circulation. In the FIG. 3A the regions of the primary part 11 which lie within the respective winding on one of the coils are characterized in dependence on the respective sense of circulation of the current I_{P} by one of the symbols “I” or “II”. In operation of the electric motor 10 the current I_{P} can be either a direct current or an alternating current. The magnetic field produced in the environment of the conductor track 40 by the current Iₚ has a different (opposite) polarity each time in the regions distinguished by “I” and “II”. If I_{P} is a direct current, then a static magnetic field arises which changes polarity in each instance on transition between the regions “I” and “II”. If I_{P} is an alternating current, then the respective polarity changes as a function of time “t” and a travelling magnetic field arises which travels in the “Z” direction.

As FIGS. 3B-C show, the construction of the devices 13 and 13′ arranged in the secondary part 12 substantially correspond with the construction of the primary part 11 if the respectively different lengths of the devices 13, 13′ or of the primary part 11 in the “Z” direction are disregarded.

The devices 13, 13′ arranged in the secondary part 12 each comprise a substrate 50, on the base surfaces of which a conductor track 60 is applied. The conductor track 60 has two ends that are each connected with a respective electrical terminal 67 or 68. An electrical voltage U_{S} can be applied to the electrical terminals 67 and 68 in order to supply the conductor path with an electrical current I_{S}. The conductor track 60 has conductor track sections 61 and 62 which are respectively arranged on different sides of the substrate 50 and are connected together at their respective ends each time by way of an electrical connection 65. For clarification, the conductor track sections 61 disposed on the base surface of the substrate 50 facing the observer are each illustrated in FIG. 3B by solid lines and the conductor track sections 62 disposed on the base side of the substrate 50 remote from the observer are each illustrated by dashed lines. The conductor track sections 61 and 62 are connected in series in such a manner that several coils each with a respective winding are formed on the substrate 50. The coils are in that case lined up in the “Z” direction to lie directly adjacent to one another. The conductor track sections 61 and 62 are connected in such a manner that adjacent coils are flowed through by the current I_{S} each time with opposite sense of circulation. In FIG. 3B the regions of the device 13 or 13′ lying within the respective winding of one of the coils are characterized, in dependence on the respective sense of circulation of the current I_{S}, by an arrow which indicates the respective sense of circulation of the current I_{S} and one of the symbols “+” or “−”. In operation of the electric motor 10 the current I_{S} is a direct current. The magnetic field produced in the environment of the conductor track 60 by the current I_{S} is a static magnetic field and has a different (opposite) polarity each time in the regions distinguished by “+” and “−”.

The regions “I” and “II” of the primary part 11 have the same length in the “Z” direction. The regions “+” and “−” of the devices 13 and 13′ each have the same length in the “Z” direction. The secondary part 12 is matched to the primary part 11 to the extent that the regions “+” and “−” of the devices 13 and 13′ have substantially the same length in the “Z” direction as the regions “I” and “II”.

In order to move the primary part 11 relative to the secondary part 12 to operate the electric motor 10 a direct current is selected as the current I_{S} and an alternating current is selected as current I_{P}. In this case the primary part 11 and the secondary part 12 moved synchronously by the magnetic field generated by the current I_{P} and travelling in the “Z” direction along the primary part 11. Whether the primary part 11 is moved in the (+Z) direction or in the (−Z) direction opposite thereto is determined by the instantaneous phase position of the alternating current I_{P} in dependence on the instantaneous position of the primary part 11 relative to the secondary part 12. In order to prevent movement of the primary part 11 relative to the secondary part 12, several possibilities are available for selection: a direct current can equally be selected as the current I_{P} or I_{P}=0 or I_{S}=0 can be realized. In order to control operation of the electric motor 10 each time a control (not illustrated in FIGS. 1A-B and 3A-C) is accordingly provided which controls the current I_{S} and the current I_{P} with respect to the amplitude, phase position and frequency in each instance depending on the instantaneous position of the primary part 11 relative to the secondary part 12.

The substrates 30 and 50 can preferably be made of an electrically insulating material having a high strength, for example of a plastic material or a ceramic material. It is of advantage if the substrates 30 and 50 are made of a non-ferromagnetic material. In this case interference forces between the primary part 11 and the secondary part 12 can be avoided and thus the relative movements between the primary part 11 and the secondary part 12 controlled with a high degree of accuracy.

The construction of the devices 13 and 13′ arranged in the secondary part 12 and of the primary part 11 can be modified in many ways within the scope of the invention. The conductor tracks 40 and 60 could each be covered by an insulating layer, for example in such a manner that the surfaces of the primary part 11 or of the devices 13 and 13′ are formed by a planar insulating layer. The conductor tracks 40 and 50 could alternatively be guided in such a manner that the regions “I” and “II” and/or “+” and “−” are respectively surrounded by conductor track sections which each form a coil with several windings. In addition, the coils can also be formed by conductor track sections which are constructed merely on one side of the substrates 30 and 50. Coils with several windings can be constructed, for example, in layer structures of several layers which each comprise electrically conductive and electrically insulating regions. The different layers can be successively applied to the substrate 30 or 50 and optionally suitably structured.

The primary part according to FIG. 3A represents a simple example for a single-phase controllable primary part. Alternatively, the primary part 11 can also be provided with several conductor tracks that can be supplied with an electric current independently of one another. In this case different alternating currents with respectively different phase could be fed to the conductor tracks in order to produce a travelling magnetic field. The arrangement of the different conductor tracks arranged in the primary part 11 can be determined geometrically with respect to the arrangement of the regions, which are denoted by “+” and “−”, of the devices 13 and 13′ in order to optimize the electric motor. Concepts for optimizations of the primary part in that way are known from, for example, Patent Applications EP 0 949 749 A1 and WO 00/49702 A1.

The secondary part 12 comprises the two devices 13 and 13′ which are of identical construction and which are in addition arranged symmetrically with respect to the primary part 11. This arrangement has the advantage that during operation of the electric motor 10 no forces arise between the primary part 11 and the secondary part 12 which act perpendicularly to the “Z” direction (i.e. the direction in which the primary part 11 is movable relative to the secondary part 12). Alternatively, the secondary part 12 could also be replaced by a secondary part which has merely one of the devices 13 and 13′.

The above details with respect to the electric motor 10 according to FIGS. 1A-B are transferable in analogous manner to the electric motor according to FIGS. 2A-B, wherein it is merely to be noted that the primary part 21 has a greater length extent in the “Z” direction than the secondary part 22. Correspondingly, the primary part 21 can have the same construction as the primary part 11 illustrated in FIG. 3A and the devices 23, 23′ can have the same construction as the devices 13, 13′ illustrated in FIG. 3B, with the significant difference that the primary part 21 should have by comparison with the devices 23, 23′ a greater number of coils—respectively arranged one after the other in a row in the “X” direction—so that the secondary part 22 is movable along the entire length of the primary part 21 when a magnetic field travelling in the “Z” direction along the primary part 21 is produced during operation of the electric motor 20.

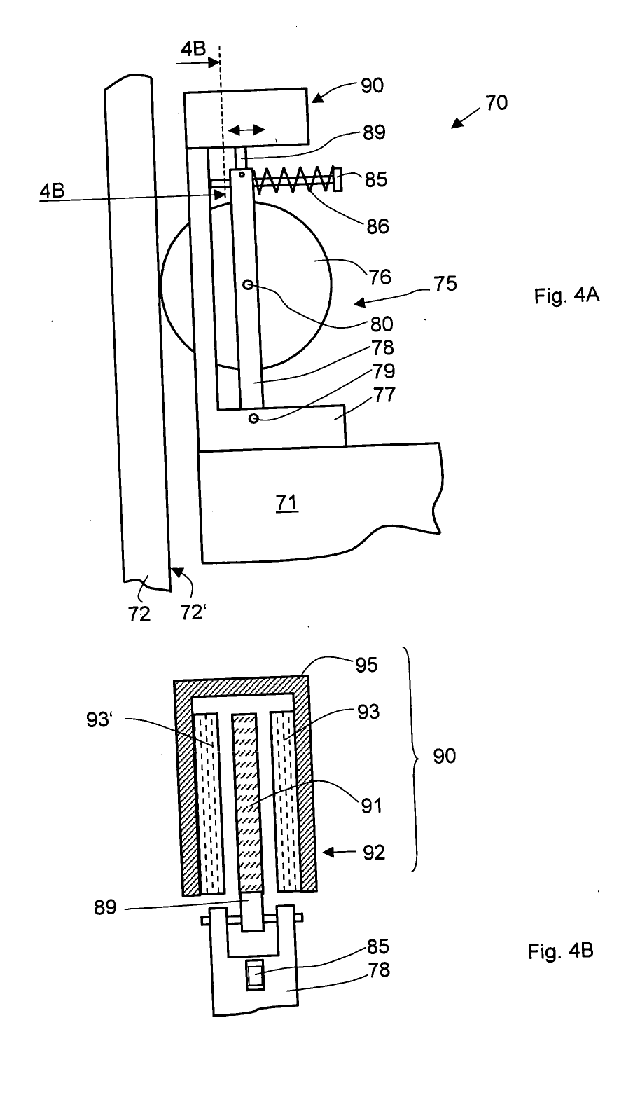

FIGS. 4A-B and 5A-B show two different uses for an electric motor, which is constructed in accordance with the present invention, in an elevator.

FIG. 4A shows an electric motor 90 which is constructed in accordance with the present invention and which is installed in an elevator 70. The elevator 70 comprises a car 71 which is guided along a guide surface 72′ at a guide rail 72. Merely a part of the elevator 70 in the immediate vicinity of the electric motor 90 is shown in FIG. 4A. A drive for moving the car 71 along the guide surface 72′ and other usual elevator components are not illustrated. A guide device 75 is provided for guidance of the car 71 along the guide surface 72′. The guide device 75 comprises: (i) a support 77 which is mounted at the car 71; (ii) a guide element 76 which is constructed as a roller rotatable about a rotational axle 80; (iii) a lever 78 in which the rotational axle 80 is mounted and which is pivotable about a rotational axle 79 mounted in the support 77 and arranged at one end of the lever 78; (iv) a rod-shaped guide device 85 which is arranged at the support 77 and serves for guidance of the end of the lever 78 remote from the rotational axle 79; (v) a spring 86 which is arranged between the lever 78 and one end of the guide device 85 and biased in such a manner that the guide element 76 on each movement of the car 71 along the guide rail 72 is brought into contact with the guide surface 72′ and is pressed by a specific force (predetermined in specific limits) against the respective guide surface 72′. The guide element 78 can be moved relative to the car 71 by means of a pivot movement of the lever 78 about the rotational axis 79. In the present case the guide element 76 rolls, in the case of movement of the car 71 along the guide surface 72, on the respective guide surface 72′.

The electric motor 90 is fastened to the support 77 and the lever 78 in such a manner that the instantaneous position of the guide element 76 with respect to the car 71 can be changed in an electronically controlled manner with the help of the electric motor 90.

FIG. 4B shows the electric motor 90 in a section 4B-4B according to FIG. 4A. The electric motor 90 is designed as a linear motor and is constructed substantially like the electric motors 10 and 20. The electric motor 90 comprises a primary part 91 for producing a travelling magnetic field and a secondary part 92 for providing a static magnetic field. The secondary part 92 substantially corresponds with respect to its construction to the secondary parts 12 and 22 of the electric motors 10 and 20, respectively. The secondary part 92 comprises two devices 93 and 93′, which are constructed like the devices 13 and 13′ and can be realized, for example, according to the layout indicated in FIGS. 3B-C. Correspondingly, the devices 13 and 13′ each comprise a respective conductor track which is arranged on the substrate and which can be supplied with an electric current for the purpose of producing a static magnetic field. The respective substrates are plate-shaped and have planar surfaces. The devices 93 and 93′ are arranged parallel to one another and fastened to a support 95, which—as shown in FIG. 4B-has a U-shaped cross-section, in such a manner that an air gap is formed between the devices 93 and 93′. The primary part 91 is arranged to be movable in this air gap. The primary part 91 substantially corresponds with respect to its construction to the primary parts 11 and 21 of the electric motors 10 and 20, respectively. It can be realized, for example, according to the layout indicated in FIG. 3A. For producing the travelling magnetic field a conductor track, which is arranged on the substrate and can be supplied with an alternating current is, for example, provided. In the case of supply of the secondary part 92 with a direct current and in the case of supply of the primary part 91 with an alternating current the primary part 91 can be moved relative to the secondary part 92 (synchronously with the travelling magnetic field produced by the primary part 91). This movement takes place in the present case in the longitudinal direction of the guide device 85, as is indicated in FIG. 4A by a double arrow. As is illustrated in FIGS. 4A-B, the secondary part 92 is fastened to the support 77. In addition, the end of the lever 78 remote from the rotational axle 79 is connected with the primary part 91 by means of a connecting element 89. Correspondingly, in operation of the electric motor 90 a movement of the primary part 91 is accompanied by a pivot movement of the lever 78 about the rotational axle 79. The guide element 76 can thus be moved relative to the car 71 by a suitable electrical control of the electric motor 90. Correspondingly, the position of the car 71 relative to the guide surface 72′, with which the guide element 76 is disposed in contact, can be moved. In particular it is possible to vary the spacing between the car 71 and the guide surface 72′ in controlled manner in the region by a suitable electrical controlling in drive of the electric motor 90.

A motor control (not illustrated) for the electric motor 90 is provided in the elevator according to FIGS. 4A and 4B, which controls, in dependence on signals of suitable sensors, the currents for supply of the primary part 91 and the secondary part 92 or the devices 93 and 93′ with respect to, for example, their amplitude, frequency and phase position in order to influence the position of the guide element 76 relative to the car 71 according to predetermined criteria. For example, sensors can be provided which during travel of the elevator car along the guide surface 72′ detect vibrations of the car 71 which occur transversely to the direction of movement of the car 71. These vibrations can be reduced or, in a given case, suppressed in that the motor control induces the electric motor 90, depending on signals of these sensors, to movements which lead to compensation for the vibrations of the car 71.

The elevator 70 according to FIGS. 4A and 4B can be modified in various ways within the scope of the present invention.

In one variant the electric motor can be so arranged with respect to the guide device 75 that the primary part 91 is stationary relative to the elevator car 71 and the secondary part 92 together with the guide element 75 is movable relative to the car 71. Moreover, it is possible to dispense with one of the devices 93 and 93′. In addition, the primary part 91 can have several conductor tracks which can be supplied with current independently of one another in order to produce the travelling magnetic field by several currents. These currents can have several different phases. In this case the current supply for the primary part has to be designed to be multi-phase and the motor control for the electric motor 90 has to be suitably adapted in order to suitably control the currents, which flow through the respective conductor tracks of the primary part 91, with respect to their amplitude, frequency and phase. Furthermore, the support 95 for the devices 93 and 93′ can be made of a soft magnetic material in order to concentrate a magnetic flux on the sides of the devices 93 and 93′, which are remote from the primary part 91, in the support 95.

In a further variant of the elevator 70 the car 71 can be guided at several of the guide rails 72 (for example at two rails arranged parallel to one another) and several of the guide devices 75 can be fastened at the car 71 in order to guide the car 71 along the respective guide rails 72. Several of the guide devices 75 could also be fastened to the car 71 for guidance of the car 71 at a respective one of the guide rails 72, for example two guide devices 75 spaced in the longitudinal direction of the respective guide rail 72. The guide rails 72 can also have, additionally to the already described guide surface 72′, further guide surfaces suitable for guidance of the car 71 in the longitudinal direction of the respective guide rail 72. Each of the guide rails 72 could have, for example, two or three guide surfaces extending in the longitudinal direction of the guide rail 72, wherein respectively adjacent guide surfaces—referred to a cross-section of the respective guide rail 72—are arranged at an angle of less than 180° (for example 90°) relative to one another. Correspondingly, several guide devices 75 can be arranged at the car 71 in such a manner that the car 71—as described in connection with FIG. 4A—is brought into contact with each of the guide surfaces by way of at least one guide element 76 (preferably by way of two of the guide elements 76), wherein the guide elements 76 are each movable with respect to the car 71 and the springs 86 are each biased in such a manner that the guide elements 76 act by a finite force on the respective guide surfaces even when the car 71 is moved along the guide rail 72 and this should be disposed under the influence of disturbing forces which are oriented transversely to the direction of movement of the car 71 and can excite the car into corresponding vibrations. The arrangement of the car 71 with respect to all guide elements 76 can, as is described above in connection with FIGS. 4A-B, be electronically controlled in variable manner by a corresponding number of the electric motors 90. In order to render the car 71 insensitive relative to vibrations transversely to the direction of movement thereof, all relevant degrees of freedom of the car 71 with respect to oscillation can be detected in terms of measurement by sensors. For reduction in the vibrations a motor control can be provided which appropriately controls the electric motor 90 in drive and induces movements which leads to compensation for the vibrations. The number and arrangement of the guide devices 75 and the electric motors 90 can be selected in correspondence with the number of degrees of freedom with respect to vibration which are to be detected by the motor control.

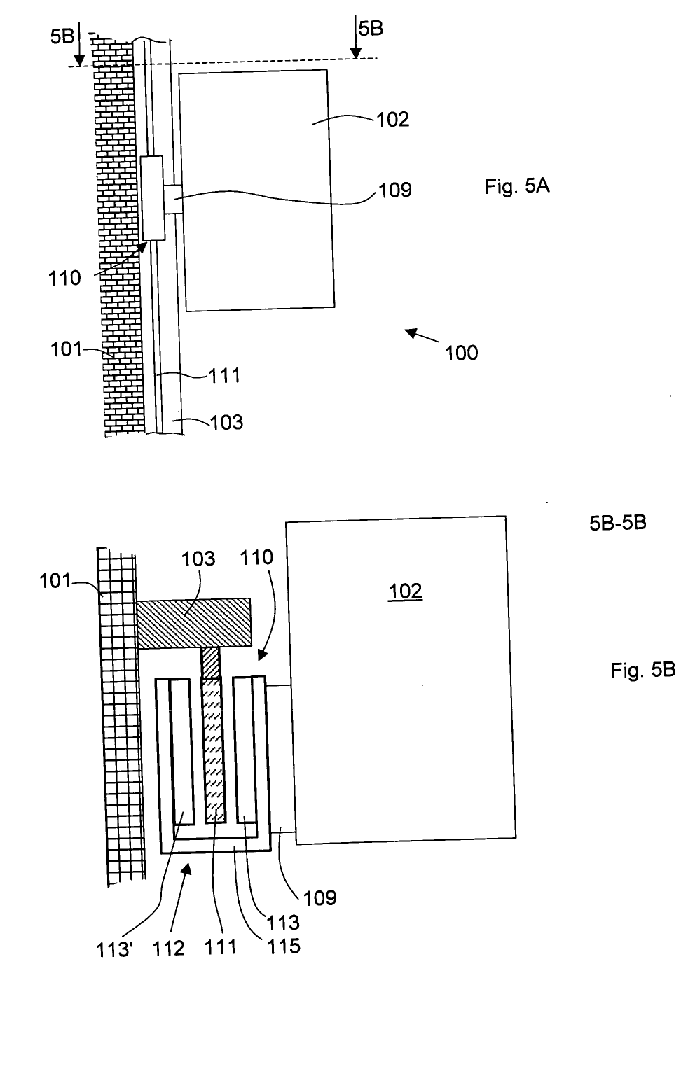

FIG. 5A shows an elevator 100 which comprises a car 102 movable along a track. FIG. 5B illustrates the elevator 100 in a section 5B-5B according to FIG. 5A.

A guide rail 103 is arranged at a wall 101 of an elevator shaft. The car is guided, in the case of movement along the track at the guide rail 103, by conventional guide means which are not, however, shown in FIGS. 5A-B. An electric motor 110 constructed in accordance with the invention serves as drive for movement of the car 102 along the guide rail 103. The electric motor 110 is conceived as a linear motor on the basis of the concepts explained in connection with the electric motors 10 and 20. The electric motor 110 comprises a primary part 111 for producing a travelling magnetic field and a secondary part 112 for providing a static magnetic field.

The primary part 111 and the secondary part 112 are arranged in such a manner that the primary part 111 and the secondary part 112 are movable relative to one another under an effect of the travelling magnetic field. The primary part 111 is arranged in such a manner that the travelling magnetic field able to be generated by the primary part 111 travels parallel to the path of the car. The primary part 111 extends along the entire length of the path of the car 102. It is fastened to the guide rail 103. The primary part 111 is composed of several modules which are arranged in succession along the path of the car and which each have a conductor track arranged on a substrate, wherein the conductor tracks of the different modules can be supplied with a current for the purpose of producing the travelling magnetic field. Each module can be constructed like, for example, the primary part 11 of the electric motor 10. The conductor tracks of the different modules can be connected in series and have a common current supply. The conductor tracks of the different modules can, however, also have a separate current supply. The latter offers the possibility of producing the travelling magnetic field —depending on the respective requirement—merely in individual part sections of the track of the car 102.

The secondary part 112 has a shorter length in the direction of the path of the car 102 than the primary part 111 and is fastened at the car 102 by a bracket 109. In the present case a connecting element 109 is arranged between the secondary part 112 and the car 102 in order to keep the secondary part 112 at a suitable spacing from the car 102.

The secondary part has—as a comparison with FIGS. 1B, 2B and 4B indicates—substantially the same structure as the secondary parts of the electric motors 10, 20 and 90.

The secondary part 112 comprises two devices 113 and 113′ which are constructed like the devices 13 and 13′ and can be realized according to, for example, the layouts indicated in FIGS. 3B-C. Correspondingly, the devices 113 and 113′ each comprise a respective conductor track which is arranged on a substrate and which can be supplied with an electric current for the purpose of producing a static magnetic field. The respective substrates are plate-shaped and have flat surfaces. The devices 113 and 113′ are arranged parallel to one and are fastened to a support 115, which—as shown in FIG. 5B-has a U-shaped cross-section, in such a manner that an air gap is formed between the devices 113 and 113′. Like the supports 15, 25 and 95, the support 115 can also be made of a soft magnetic material.

The secondary part 112 is arranged in such a manner that the primary part 111 projects into the air gap between the devices 113 and 113′ of the secondary part 112 and is not brought into contact with the devices 113 and 113′ when the car 102 is moved along the guide rail 103. The latter presupposes that the mentioned guide means for guidance of the car 102 along the guide rail 103 ensure the requisite degree of precision and rigidity.

In operation the car 102 can be moved or held at a predetermined position in that the conductor tracks of the primary part 111 and the secondary part 112 are suitably supplied with current. If the primary part 111 is controlled in a drive in such a manner that it produces a travelling magnetic field, then the car 102 is moved synchronously with the travelling magnetic field along the guide rail 103. If not only the primary part 111, but also the primary part 112 are supplied with a direct current, then the car 102 can be held at a predetermined position. The motor 110 can be so designed that the force which the electric motor 110 exerts on the car 102 in operation is sufficient to hold the car without further assistance. In this case the elevator 100 can be operated without support means for the car 102 (i.e. without a cable or belt) and without a counterweight.

The elevator 100 can be modified in numerous ways within the scope of the present invention. Since the primary part 111 and the secondary part 112—referred to the longitudinal direction of the guide rail 103—have a significantly different length, the current supply for the conductor tracks of the primary part 111 and the secondary part 112 can also be constructed in such a manner that currents flow only in the regions of the primary part 111 and of the secondary part 112 in which the primary part 111 overlaps the secondary part 112. The energy consumption of the electric motor 110 can be reduced in this manner. In a further variant the elevator 100 can be guided at several guide rails 103. The guide rails can be arranged at different sides of the car 102. Correspondingly, the car 102 can be driven by several electric motors 110. In the latter case the primary parts 111 of the different electric motors 110 can be arranged at the respective guide rails and the corresponding secondary parts 111 fastened at the car 102, for example according to the concept illustrated in FIGS. 5A and 5B.

According to a further variant of the elevator 100 the electric motor 110 can be replaced in each instance by a different electric motor constructed in accordance with the invention, the primary part of which is arranged in stationary position with respect to the car 103 and the secondary part of which is arranged in stationary position with respect to the path of the car 103. In this case the respective secondary part extends along the entire length of the track. The length of the respective primary part along the track can, thereagainst, be shortened by comparison with the length of the corresponding secondary part.

Moreover, the mentioned electric motors and the car can be guided by separate means along the path of the car 102. In addition, modifications disclosed for the electric motors 10, 20 and 90 can be analogously transferred to the electric motor 110.

In accordance with the provisions of the patent statutes, the present invention has been described in what is considered to represent its preferred embodiment. However, it should be noted that the invention can be practiced otherwise than as specifically illustrated and described without departing from its spirit or scope.

1. An electric motor having a primary part for generating a traveling magnetic field and a secondary part for providing a static magnetic field, wherein the secondary part and the primary part are movable relative to one another under an effect of the traveling magnetic field, the secondary part comprising: a substrate; a conductor track applied to said substrate in a layer structure, and wherein said conductor track can be supplied with an electric current for generating the static magnetic field.

2. The electric motor according to claim 1 wherein said substrate has a flat surface upon which said conductor track is applied.

3. The electric motor according to claim 1 wherein the primary part and the secondary part operate as a linear motor.

4. The electric motor according to claim 1 wherein at least one section of said conductor track is formed as a coil, wherein said coil has at least one winding.

5. The electric motor according to claim 1 wherein said conductor track is formed of conductor track sections which are respectively formed in different layers of said layer structure.

6. The electric motor according to claim 1 wherein a first part of said conductor track is formed at a first surface of the substrate and a second part of said conductor track is formed at a second surface of said substrate, and an electrical connection is provided between said first part and said second part.

7. The electric motor according to claim 1 wherein several serially arranged sections form said conductor track each having a form of a coil, wherein said coils are constructed in such a manner that when a current flows through said conductor track adjacent ones of said coils respectively produce magnetic fields with different polarity.

8. The electric motor according to claim 7 wherein said conductor track generates the static magnetic field at a surface of the secondary part having several regions with a periodic reversal of the polarity of the magnetic field in a direction in which the secondary part is movable relative to the primary part.

9. The electric motor according to claim 1 wherein the primary part includes another conductor track arranged on another substrate and said another conductor track is supplied with an electric current, the current intensity of which varies with time, for generating the traveling magnetic field.

10. The electric motor according to claim 1 wherein the primary part includes several conductor tracks arranged on a substrate and each of said several conductor tracks is supplied with an electric current, the current intensity of which varies with time, for generating the traveling magnetic field.

11. The electric motor according to claim 1 including an air gap, which is bounded by a planar surface of the primary part and a planar surface of the secondary part, is formed between the primary part and the secondary part.

12. The electric motor according to claim 1 wherein said layer structure of the secondary part is fastened to a support formed of a magnetic material, said support being arranged on a side of said layer structure remote from the primary part.

13. An elevator comprising:
an elevator car;
an electric motor for moving said elevator car along a path;
said electric motor having a primary part for generating a traveling magnetic field and a secondary part for providing a static magnetic field, said secondary part and said primary part being movable relative to one another under an effect of said traveling magnetic field, one of said primary part and said secondary part being attached to said car and another of said primary part and said secondary part being stationary along said path; and
said secondary part including a substrate, a conductor track applied to said substrate in a layer structure, and wherein said conductor track can be supplied with an electric current for generating said static magnetic field.

14. The elevator according to claim 13 including means for guiding said car along said track, wherein said primary part and said secondary part are arranged at said means and said primary part and said secondary part are guided at a spacing from one another when said car is moved along said path.

15. An elevator comprising:
an elevator car movable along a guide surface of a path;
a guide element arranged at said car to be movable and which is brought into contact with said guide surface; and
an electric motor for moving said guide element, said electric motor having a primary part for generating a traveling magnetic field and a secondary part for providing a static magnetic field, said secondary part and said primary part being movable relative to one another under an effect of said traveling magnetic field, one of said primary part and said secondary part being attached to said car and another of said primary part and said secondary part being attached to said guide element.

16. The elevator according to claim 15 wherein said primary part moves with said guide element and said secondary part is stationary with respect to said car.

17. The elevator according to claim 15 wherein said secondary part moves with said guide element and said primary part is stationary with respect to said car.

18. The elevator according to claim 15 wherein said electric motor is adapted to be actuated by a control for reducing of vibrations of said car during movement of said car along said guide surface.
